(19) United States
(12) Patent Application Publication
(10) Pub. No.: US 2024/0025286 A1
(43) Pub. Date: Jan. 25, 2024

(54) Inflatable Non-Imaging Non-Tracking Solar Concentrator Based CSP System Powered Recreational Vehicle Trailer as Mobile EV Charging Station

(71) Applicant: Yonghua Wang, Klamath Falls, OR (US)

(72) Inventor: Yonghua Wang, Klamath Falls, OR (US)

(21) Appl. No.: 17/803,471

(22) Filed: Jul. 25, 2022

(51) Int. Cl. B60L 53/51; B62D 63/08; B60L 53/30; B60L 53/57; B60L 53/53; H02J 7/35; H02S 10/20; H02S 10/40; H02S 30/20; H02S 40/22; H02S 40/44

(52) U.S. Cl. CPC B60L 53/51; B62D 63/08; B60L 53/30; B60L 53/57; B60L 53/53; H02J 7/35; H02S 10/20; H02S 10/40; H02S 30/20; H02S 40/22; H02S 40/44

(57) ABSTRACT

A Recreational Vehicle (RV) trailer as a mobile Electric Vehicle (EV) charging station powered by an inflatable non-imaging non-tracking solar concentrator based Concentrating Solar Power (CSP) system comprises an expandable compartment with drawer type sub-compartments, foldable hybrid solar thermal and photovoltaic panel arrays, heat pumps, thermal storage, thermal power generation system, large battery banks, and bidirectional chargers. When parked, the hybrid solar thermal and photovoltaic arrays are extended as receivers, and the inflatable non-imaging non-tracking solar concentrators are blew ups to form CSP system to cogenerate electricity and heat. The cogenerated electricity is used to charge battery banks directly, and the cogenerated heat is pumped to high temperature and stored for regeneration of power during night time. The RV trailer serves as mobile EV charging station, hotel, and solar power generation station. In addition, the RV trailers can also serve as a battery trailers for battery swapping of EV trucks.

### TECHNICAL FIELD

The present disclosure relates generally to Electric Vehicle (EV) charging station, more specifically, to inflatable non-imaging non-tracking solar concentrator based Concentrating Solar Power (CSP) system powered expandable Recreational Vehicle (RV) trailer as mobile EV charging station.

### BACKGROUND

There is no doubt that Electric Vehicle (EV) will dominate the transportation market in the future. However, the wide-spread adoption of EVs is still impeded by the charging infrastructure. Although it is very well accepted that rapid growth of EV number will make EV charging a highly profitable industry, the current electric power grid infrastructure is unable to satisfy demand for constructing EV charging stations everywhere, especially along highway and in remote areas. Constructing new power grid system, especially along highway and in remote areas, is approved prohibitively expensive. Therefore, widely distributed solar powered EV charging station network, in conjunction with mobile EV charging stations, might be the solution to address the issue of everywhere EV charging. Due to the distribution attribution of solar energy resource, solar powered EV charging network formed by stand alone solar power generation stations eliminates long distance transmission lines of conventional electric power grid system. Mobile EV charging stations can deliver the solar generated electric power to wherever needed to charge EVs. The mobile EV charging stations equipped with bidirectional chargers can also play a role to connect the distributed solar power generation network to the conventional electric power grid system to form much broader mobile electric power grid. The success of this approach will not only radically address the issue of EV charging, but also dramatically leverage solar industries. At present, although there are some mobile EV charging stations available, most of them are modified vehicles, they are not collapsible inflatable non-imaging non-tracking solar concentrator based CSP powered. Neither are they multi-functional as RV, nor battery trailers.

U.S. Pat. No. 8,963,481 B2 granted to Prosser et al (Prosser) disclosed a charging service vehicle which transports battery modules to provide roadside assistance or rescue. Prosser's invention is able to transport the power generated by the solar power generation stations in other areas to the EV charging sites for charging EVs, but can't generate power locally at the EV charging sites by using solar power. Presser's vehicle has only single function and can't be applied for other applications.

US patent 2015/0288317 A1 applied by Huang et al (Huang) disclosed a solar power mobile charging station which includes a foldable solar panel and a battery configured to receive electricity generated from the solar panel and charge one or two electric vehicles. In Huang's disclosure, the solar power charging system is towered or driven to where the EVs are located, the system itself has no driving system. Huang's system is based on flat plate photovoltaic panel which has limited conversion efficiency, significant cost, and non-negligible self weight. In Huang's system, the electric power is generated locally with a foldable solar panel to charge EVs. But, the system is neither able to transport the power generated in fixed solar power generation stations located in other areas to charge EVs, nor able to transport electric power from power grid to the EV charging sites. Furthermore, Huang's system is limited by the low conversion efficiency and heavy weight of the conventional solar panels. In Huang's system, only battery is deployed to store the solar panel generated electric power, no mechanism is deployed to store the solar panel generated thermal energy and enhance electric power regeneration and storage.

U.S. Pat. No. 9,505,307 B2 granted to Champagne et al (Champagne) discloses a “solar-thermal powered recreational vehicle”. Champagne's RV is featured by solar thermal air conditioning system and solar photovoltaic panel electric power supply system. In Champagne's design, the solar thermal collectors and photovoltaic panels are separate devices which occupy the limited roof areas of RV independently. Champagne's solar thermal system and photovoltaic system are based on flat plate panels rather than Concentrating hybrid solar thermal and photovoltaic system Champagne's RV is just a RV not a mobile EV charging station.

The objective of the present invention is to provide a expandable RV trailer that is powered by inflatable non-imaging non-tracking solar concentrator based CSP system and equipped with large battery banks and bidirectional chargers to charging EVs. The entire RV trailer can be used as battery trailer for ET to realize battery swapping. The RV trailer serves as mobile EV charger during daytime and as mobile hotel during night time.

### SUMMARY

According to the present invention, a towable expandable RV trailer comprises: a compartment made of multiple inter-penetrated sub-compartments with hybrid solar thermal and photovoltaic panel roofs and retractable independent hybrid solar thermal and photovoltaic panel arrays as receivers of the inflatable non-imaging non-tracking solar concentrator based CSP system; bidirectional chargers; large battery banks; inflatable non-imaging non-tracking solar concentrators; heat pumps; and thermal power generation system. In operation, the inflatable non-imaging non-tracking solar concentrator concentrates solar radiation and couples the concentrated sunlight onto the hybrid solar thermal and photovoltaic panels to cogenerate electricity and heat, the electricity is directly stored into the battery banks and the co-generated heat is taken by the heat pump to raise its temperature and then taken by thermal power generation system to regenerate electricity. In this design paradigm of RV trailer, the hybrid solar thermal and photovoltaic panels are adopted to significantly increase overall conversion efficiency of the solar system; the foldable hybrid solar thermal and photovoltaic arrays and roofs of the RV trailer, in conjunction with the inflatable non-imaging non-tracking solar concentrators, dramatically increase the solar collection areas; and the addition of bidirectional chargers and large battery banks makes the RV trailer a mobile EV charging station.

During daytime, the RV trailer serves as large scale solar collection field and EV charging station. During night time, the RV trailer serves as mobile hotel.

Further aspects and advantages of the present invention will become apparent upon consideration of the following description thereof, reference being made of the following drawings.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is the RV trailer with expandable sub-compartments and hybrid solar thermal and photovoltaic arrays.

FIG. 2 is the RV trailer with the expandable sub-compartments and hybrid solar thermal and photovoltaic arrays pulled out.

FIG. 3 is the RV trailer with the expandable sub-compartments and hybrid solar thermal and photovoltaic arrays pulled out, as well as the inflatable non-imaging non-tracking solar concentrators blew up.

FIG. 4 is the indication of the RV trailer with the battery banks and bidirectional chargers installed.

FIG. 5 is block diagram indicating the configuration of the hybrid solar thermal and photovoltaic collection, thermal storage, thermal power generation, and battery banks and bidirectional charging system.

FIG. 6 structure of the hybrid solar thermal and photovoltaic panel.

FIG. 7 is explanation of work principle of non-imaging Compound Parabolic Concentrator (CPC) for concentrating both beam light and diffuse light.

FIG. 8 is the non-imaging non-tracking solar concentrator.

FIG. 9 is explanation of work principle of the non-imaging non-tracking CPC with the divergent Fresnel lens optical cover.

### DETAILED DESCRIPTION

Reference will now be made in detail to the present exemplary embodiments, examples of which are illustrated in the accompanying drawings. Wherever possible, the same reference numbers will be used throughout the drawings to refer to the same or like parts.

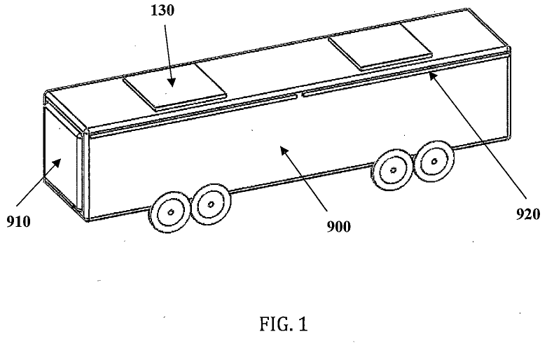

Referring to FIG. 1, the RV trailer comprises a compartment 900, 2 drawer type expandable sub-compartments 920, 4 foldable hybrid solar thermal and photovoltaic panel arrays 910, and hybrid solar thermal and photovoltaic arrays 130 on roof of the compartment.

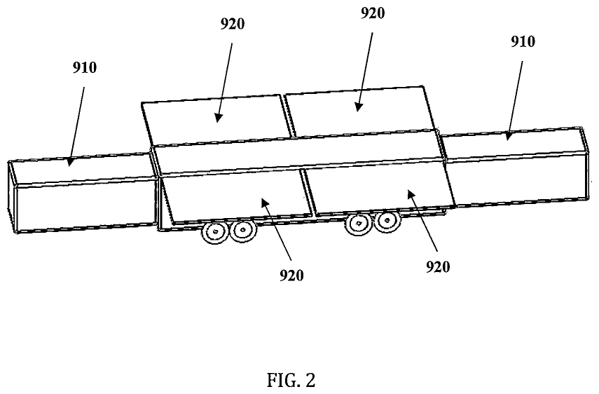

Referring to FIG. 2, the sub-compartments 920, and the drawer type hybrid solar thermal and photovoltaic panel arrays 910 can be pulled out to extend area for collecting solar radiation when the RV trailer is parked somewhere.

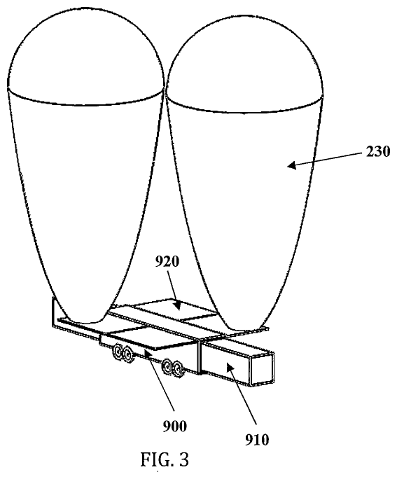

Referring to FIG. 3, the inflatable non-imaging non-tracking solar concentrators 230 are blew up to form CSP when the RV trailer is parked somewhere.

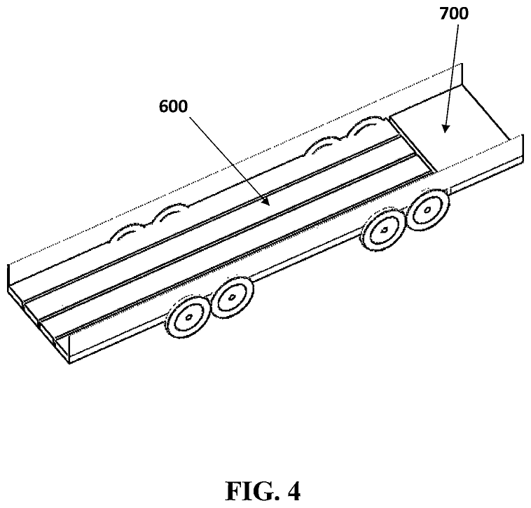

Referring to FIG. 4, the cogenerated electric power from the hybrid solar thermal and photovoltaic system and the regenerated electric power from the CSP system can be stored into the battery banks 600 and used to charge other EVs through the bidirectional charger 800.

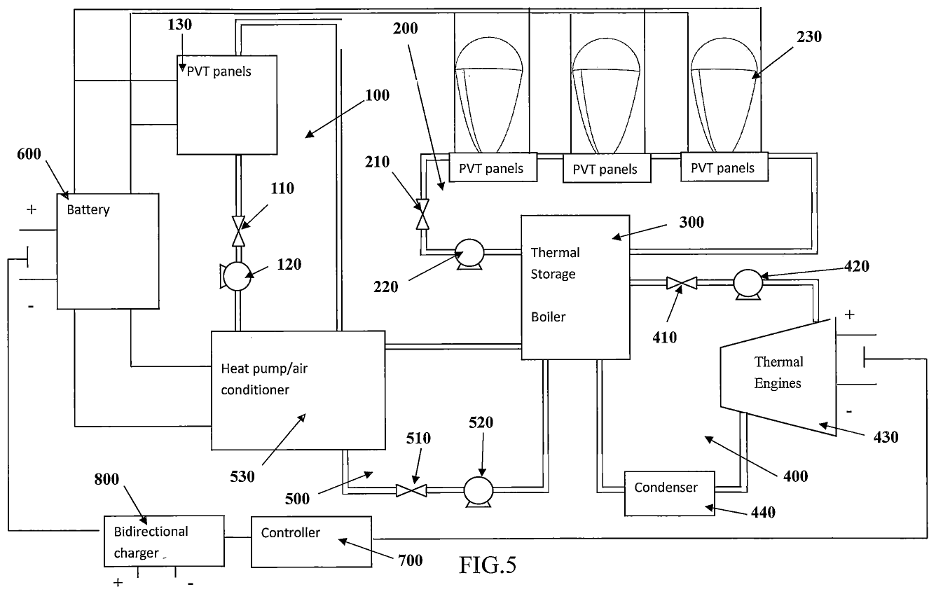

Referring to FIG. 5, when in operation, the hybrid solar thermal and photovoltaic arrays 130 cogenerate electricity, which is directly stored into the battery banks 600, and heat, which is heated up to high temperature through valves 110, 510 and pumps 120,520 by thermal pumps 530, which are also used as air conditioners for the RV trailer, and inflatable non-imaging non-tracking solar concentrators 230 through valves 210 and pumps 220, then is stored into the thermal storage 300. The stored thermal energy is then taken by thermal engine 430 to regenerate electric power through valves 410, pumps 420, and condenser 440 to charge battery banks 600. The stored electric power is used to charge other EVs through bidirectional charger 800. The entire system is controlled by the controller 700.

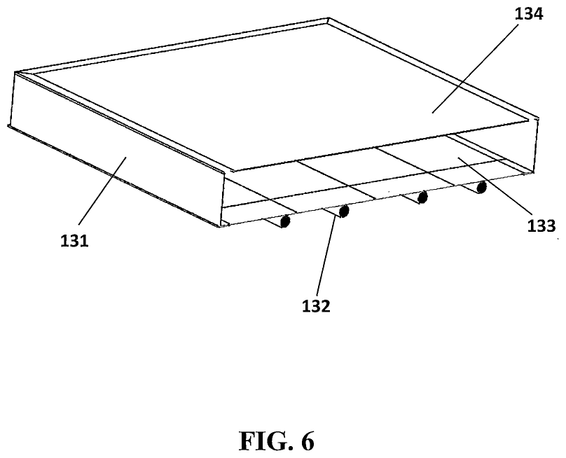

Referring to FIG. 6, the hybrid solar thermal and photovoltaic panel 130 comprises a transparent cover 134, laminated photovoltaic panel and metal sheet 133, frame work 131, and circulation pipes 132.

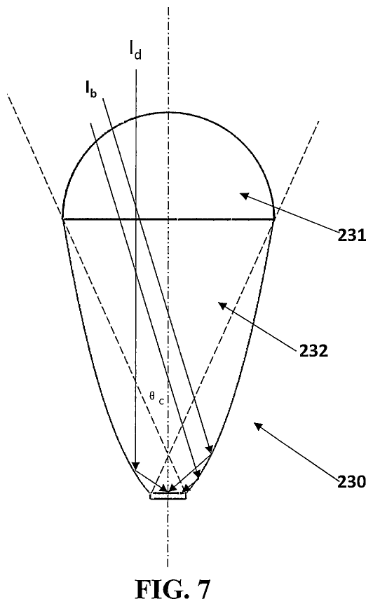

Referring to FIG. 7, both of the beam light I_{b} and diffuse light Id penetrating through the transparent cover 231 of CPC 232 with incident angle smaller than the acceptance half angle θ_{c} are concentrated to receiver at bottom.

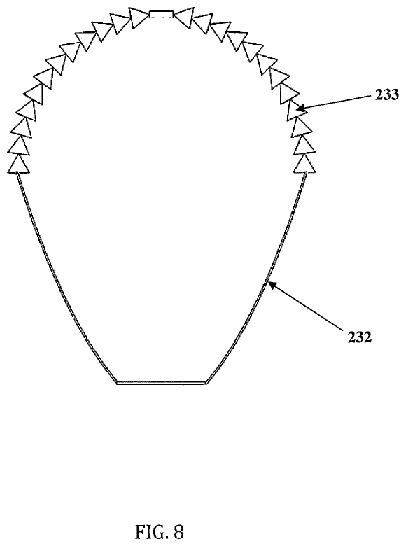

Referring to FIG. 8, the non-imaging non-tracking solar concentrator is formed by adding a domed divergent Fresnel lens 233 on the top of the transparent cover 231 of the CPC 232.

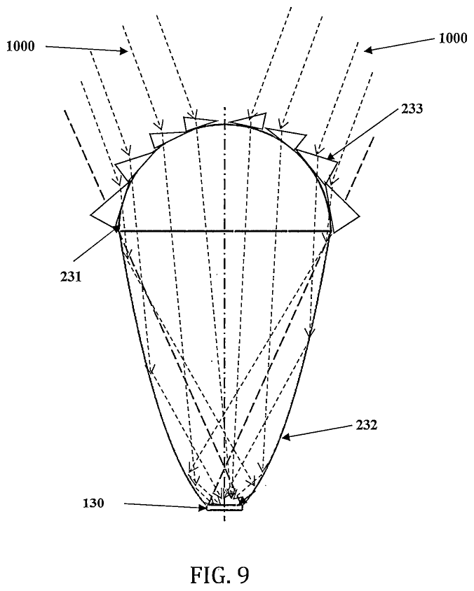

Referring to FIG. 9, when in operation, the oblique incident sunlight 1000 is firstly refracted by the domed divergent Fresnel lens 233 to reduce the incident angle relative to the CPC 232, and then is concentrated by 232.

From the description above, a number of advantages of the solar concentrator become evident: 1) RV trailer is used as EV charging station during daytime and hotel during night time; 2) RV trailer has expandable sub-compartments and hybrid solar thermal and photovoltaic arrays to extend solar collection areas; 3) hybrid solar thermal and photovoltaic panels are employed to increase total conversion efficiency and cogenerate electricity and thermal energy; 4) inflatable non-imaging non-tracking solar concentrator is deployed to dramatically enlarge solar collection area and form CSP system; 5) thermal storage is deployed to store thermal energy; 6) heat pump is deployed as both electric heater and air conditioner; 7) bidirectional charger is deployed to charge the battery banks and other EVs; 8) the RV trailer is a mobile solar power generation station and EV charging station; 9) the entire solar system is of ultra-high efficiency, extremely low cost, and super-light weight.

In the preceding specification, various preferred embodiments have been described with reference to the accompanying drawings. It will, however, be evident that various other modifications and changes may be made thereto, and additional embodiments may be implemented, without departing from the broader scope of the invention as set forth in the claims that follow. The specification and drawings are accordingly to be regarded in an illustrative rather than restrictive sense.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

I claim:

1. A Recreational Vehicle (RV) trailer comprises: 1) an expandable compartment with hybrid solar thermal and photovoltaic arrays installed on its roof; 2) drawer type sub-compartments with hybrid solar thermal and photovoltaic arrays installed on their roofs; 3) foldable hybrid solar thermal and photovoltaic panel arrays beneath the roof of the compartment; 4) inflatable non-imaging non-tracking solar concentrators; 5) heat pumps; 6) a thermal storage; 7) thermal power generation system; 8) large battery banks; 9) bidirectional chargers; 10) a control system.
Wherein, all of the hybrid solar thermal and photovoltaic arrays are connected to the large battery banks through electric cables; in operation, the inflatable non-imaging non-tracking solar concentrators are installed on the tops of some of the hybrid solar thermal and photovoltaic arrays; those of hybrid solar thermal and photovoltaic arrays without inflatable non-imaging non-tracking solar concentrators are connected to thermal storage through valves, pumps, pipes, and heat pumps; those of the hybrid solar thermal and photovoltaic arrays with inflatable non-imaging non-tracking solar concentrators are connected to thermal storage through valves, pipes, and pumps directly; the thermal storage is connected to the thermal power generation system through valves, pipes, and pumps; the thermal power generation system is connected to the large battery banks through electric cables; the large battery bank is connected to the bidirectional charger; all components are connected to the control system through electric cables.

2. The RV trailer of claim 1, wherein the sub-compartments with hybrid solar thermal and photovoltaic arrays on their roofs are inserted into the compartment.

3. The RV trailer of claim 1, wherein the foldable hybrid solar thermal and photovoltaic arrays are inserted into the compartment beneath the roof of the compartment.
